(19) United States
(12) Patent Application Publication
(10) Pub. No.: US 2006/0053325 A1
(43) Pub. Date: Mar. 9, 2006

(54) Storing system information in a low-latency persistent memory device upon transition to a lower-power state

(76) Inventors: Ram V. Chary, Portland, OR (US); Vittal Kini, Aloha, OR (US); Rick Leiss, Lafayette, CO (US); Pradeep Sebestian, Aloha, OR (US)

Correspondence Address: Buckley, Maschoff & Talwalkar LLC;Attorneys for Intel Corporation, Five Elm Street, New Canaan, CT, 06840, US

(21) Appl. No.: 10/934,655

(22) Filed: Sep. 3, 2004

(51) Int. Cl. G06F 1/26

(52) U.S. Cl. 713/320

(57) ABSTRACT

According to some embodiments, it may be determined that a processing system is to transition from a higher-power state to a lower-power state. System information may then be copied from a volatile memory device to a low-latency persistent memory device, and it may be arranged for the processing system to transition from the higher-power state to the lower-power state.

### BACKGROUND

A processing system consumes power as it operates. For example, a processing system associated with a mobile computer might consume power from a battery. As the performance of a processing system is improved (e.g., by increasing the speed of the processor, allowing wireless communication, providing a larger display, and/or executing more complex applications), the amount of power consumed by the processing system may increase. As a result, a battery may need to be re-charged more frequently, which might be annoying for a user. Note that increasing the size of the battery might be impractical (e.g., because it would make a mobile computer too large).

To conserve power, a processing system may have a number of different power states. For example, the processing system might operate in a higher-power state when it is actively being used and in a lower-power state during periods of relative inactivity. In some case, however, the processing system may be unavailable while it transitions from a lower-power state to a higher-power state (e.g., it might take twenty seconds to complete the transition). Such a delay might be inconvenient for a user. Moreover, the delay might be inappropriate for some applications, such as a Voice Over Internet Protocol (VoIP) telephone (e.g., because a user may not want to wait ten seconds before he or she is able to make a telephone call).

### BRIEF DESCRIPTION OF THE DRAWINGS

FIG. 1 is a block diagram of a processing system.

FIG. 2 is a block diagram of a processing system according to some embodiments.

FIG. 3 is a flow chart of a method associated with a transition to a lower-power state according to some embodiments.

FIG. 4 is a method associated with a transition back to a higher-power state according to some embodiments.

FIG. 5 is a block diagram of a processing system according to some embodiments.

FIG. 6 is a block diagram of hardware and software power management components according to some embodiments.

FIG. 7 illustrates a computer system according to some embodiments.

### DETAILED DESCRIPTION

Some embodiments described herein are directed to a “processing system.” As used herein, the phrase “processing system” may refer to any apparatus that includes one or more processors. Examples of processing systems include a desktop Personal Computer (PC), a mobile computer, a workstation, a server, a set top box (e.g., associated with a digital television receiver), a wireless telephone, a consumer electronic device, and a game system.

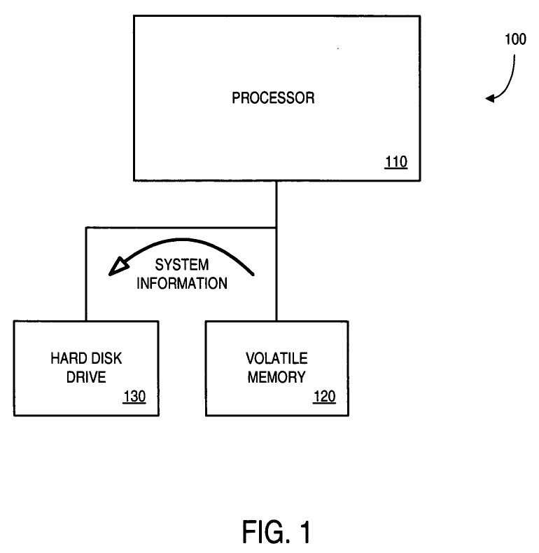

For example, FIG. 1 is a block diagram of a processing system 100. In particular, the processing system 100 includes a processor 110, such as an INTEL® PENTIUM® IV processor. The processor 110 may execute, for example, an operating system and/or a number of applications. By way of example, the processor 110 might execute the MICROSOFT® WINDOWS® XP operating system, the MICROSOFT® INTERNET EXPLORER 5.0® web browser, and a media player adapted to provide audio output in accordance with audio layer 3 of the Motion Picture Experts Group (MPEG) 1 protocol as defined by International Organization for Standardization (ISO)/International Engineering Consortium (IEC) document number 11172-1 entitled “Information Technology—Coding of Moving Pictures and Associated Audio for Digital Storage Media” (1993) (MP3). Note that any number of other applications may be executing in addition to, or instead of, the web browser and MP3 player.

The processor 110 may store system information in a volatile memory device 120 as it executes the operating system and applications. The volatile memory device might be, for example, a system Random Access Memory (RAM) device. Note that when in an “idle” state, the processing system 100 may need to periodically “refresh” the volatile memory to ensure that information will not be lost. The processor 110 may also store and retrieve information from a hard disk drive 130 (e.g., the processor 110 might retrieve an MP3 file from the hard disk drive 130).

To conserve power, the processing system 100 might be able to operate in a number of different power states. For example, the processing system 100 might operate in a higher-power state when it is actively being used and in a lower-power state during periods of relative inactivity. While in a lower-power state, for example, the processor 100, various buses, and/or other devices might be turned off.

To reduce the amount of power being consumed when in a lower-power state, the processing system 100 might stop refreshing the volatile memory 120. That is, any information stored in the volatile memory 120 would be lost when processing system 100 transitions to the lower-power state. As a result, when the processing system 110 returns to the higher-power state it might be unable to return to the same state that existed when the lower-power state was originally entered.

By way of example, consider a user who executes a word processing application on a mobile computer and begins to create a document. If the user leaves mobile computer for an extended period of time, the mobile computer may enter a lower-power state (e.g., after no input from the user has been received for five minutes). When the user returns, the mobile computer may transition back to the higher-power state. Because the system RAM was not refreshed while in the lower-power state, however, the mobile computer might not re-execute the word processing application and/or the information in the document might be lost.

To prevent such a result, system information may be copied from the volatile memory 120 to the hard disk drive 130 when the lower-powered state is entered (e.g., just before entering the lower power state and the volatile memory 120 refresh is stopped). In this case, the system information can be copied from the hard disk drive 130 back to the volatile memory 120 when the higher-power state is re-entered (e.g., and the state of the processing system 100 may be preserved).

Note that this approach may increase the amount of time it takes for the processing system 100 to transition back to the higher-power state. For example, it might take twenty seconds to copy the system information from the hard disk drive 130 back to the volatile memory 120. Such a delay might be annoying and inconvenient for a user. Moreover, the delay might make the processing system 100 inappropriate for some applications (e.g., a VoIP telephone).

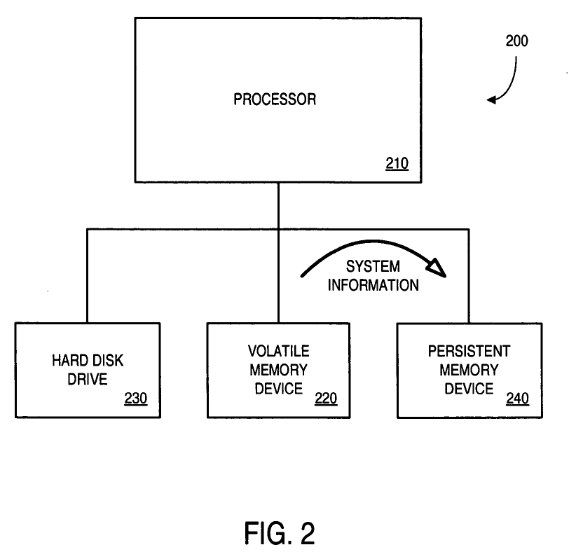

FIG. 2 is a block diagram of a processing system 200 according to some embodiments. As before, the processing system 100 includes a processor 210, such as an INTEL® PENTIUM® IV processor. The processor 210 may execute, for example, an operating system and/or a number of applications (e.g., a web browser and an MP3 player) and store system information in a volatile memory device 220, such as a system RAM. The processor 210 may also store and retrieve information from a hard disk drive 230.

To conserve power, the processing system 200 might be able to operate in a number of different power states. For example, the processing system 200 might operate in a higher-power state when it is actively being used and in a lower-power state during periods of relative inactivity.

According to some embodiments, the processing system 200 operates in accordance with the Advanced Configuration and Power Interface (ACPI) Specification Revision 2.0b (October, 2002). In particular, the processing system 200 might be able to operate in a number of different “sleep” states: S0 (fully operational and consuming the most power), S1 (a low wake latency sleep state after which no system context is lost); S2 (a low wake latency sleep state after which processor and system cache context needs to be restored); and S3 (a low wake latency sleep state in which all context needs to be restored except for the system information stored in the volatile memory device 220). In addition to these higher-power states, the ACPI defines a lower-power state S4 in which all system information stored in the volatile memory device 220 is lost.

According to some embodiments, the system information may be copied from the volatile memory 220 to a persistent memory device 240 when such a lower-powered state is entered (e.g., just before entering S4). The persistent memory device 240 might comprise, for example, an Electrically Erasable Programmable Read-Only Memory (EEPROM) device, such as a flash memory device (e.g., a NOR or NAND flash memory device). Note that the persistent memory device 240 is a solid state device (e.g., has no moving parts) and information may be retrieved from it significantly faster as compared to the hard disk drive 230.

Other examples of persistent memory devices include polymer-based memory devices, Magnetoresistive RAM (MRAM) devices, Ovonic Unified Memory (OUM) devices, Ferroelectric RAM (FeRAM) devices, Ferroelectric Polymer RAM (FePRAM) devices, and Resistance RAM (RRAM) devices.

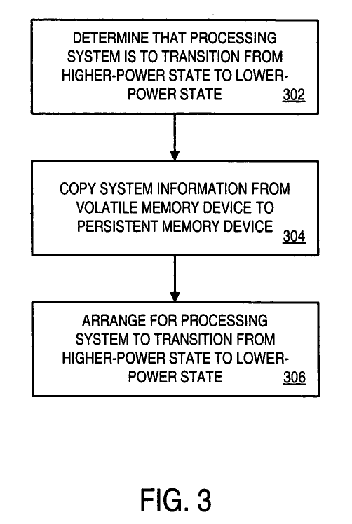

FIG. 3 is a flow chart of a method associated with a transition to a lower-power state according to some embodiments. The method of FIG. 3 may be associated with, for example, a processing system such as the one described with respect to FIG. 2. The flow charts described herein do not necessarily imply a fixed order to the actions, and embodiments may be performed in any order that is practicable. Note that any of the methods described herein may be performed by hardware, software (including microcode), or a combination of hardware and software. For example, a storage medium may store thereon instructions that when executed by a machine results in performance according to any of the embodiments described herein.

At 302, it is determined that a processing system is to transition from a higher-power state to a lower-power state. In an ACPI system, for example, it may be determined that sleep state S4 will be entered after a period of relative inactivity. According to some embodiments, the lower-power state is associated with a different sleep state (e.g., S3) or a different type of power state, such as a global state, a device power state, a processor power state, and/or a performance state. Note that the ACPI specification defines global states G0 through G3, device power states D0 through D3 (and device performance states P0 through Pn within D0), and processor power states C0 through C3.

At 304, system information is copied from a volatile memory device to a persistent memory device. For example, an operating system image may be copied from system RAM to flash memory. Moreover, any user data (e.g., applications, application data, and the state of applications) are also in the system RAM and will be stored to the low-latency, persistent flash memory.

At 306, it is arranged for the processing system to transition from the higher-power state to the lower-power state. For example, the lower-power state may be entered and refreshes to a system RAM may be halted. Note that the information in the persistent memory device can be maintained without consuming power.

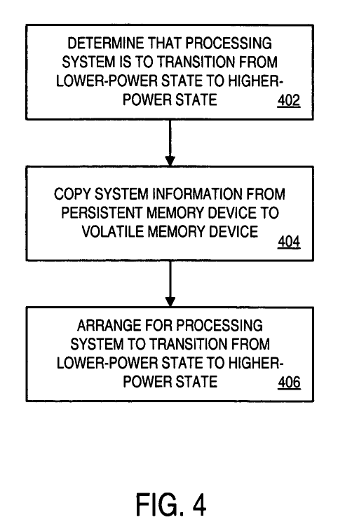

FIG. 4 is a method associated with a transition back to a higher-power state according to some embodiments. At 402, it is determined that the processing system is to transition back from the lower-power state to the higher-power state. For example, a keystroke might be detected and it may be determined that the processing system should transition from the lower-power state to ACPI sleep state S0 (fully operational).

At 404, system information is copied from the persistent memory device back to the volatile memory device. For example, a system image (e.g., including the operating system, application context, and user data) may be copied from flash memory back to system RAM. It is then arranged for the processing system to transition from the lower-power state to the higher-power state at 406. Note that because the system information has been restored to the volatile memory device, system context information may be preserved (e.g., the processing system may resume operating in the same state that existed when the transition was previously made to the lower-power state).

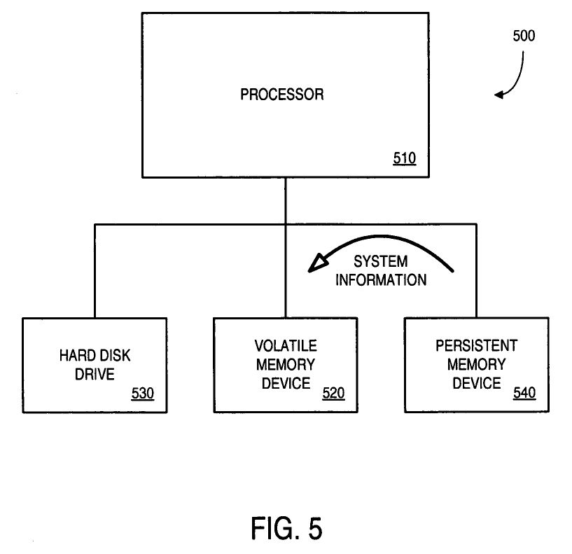

FIG. 5 is a block diagram of a processing system 500 according to some embodiments. In this case, the system information is copied from the persistent memory device 540 (e.g., flash memory) to a volatile memory device 520 (e.g., system RAM) in connection with a transition from a lower-power state to a higher-power state. Note that such a transfer may be performed more quickly as compared to a transfer from a hard disk drive 530. Moreover, a hard disk drive 530 might need to be initialized before any information can be accessed. As a result, it might only take one second to copy the system information from the persistent memory device 540 as compared to twenty seconds from the hard disk drive 530. Accordingly, this approach may allow the lower-power state be entered more frequently (e.g., because it presents less of a nuisance for the user).

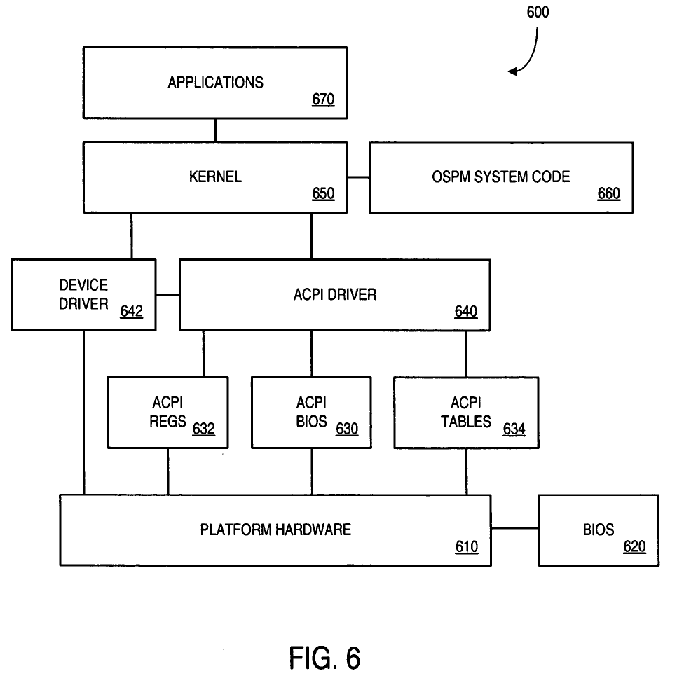

FIG. 6 is a block diagram of hardware and software power management components that may be associated with an ACPI system 600 according to some embodiments. The system 600 includes platform hardware 610, such as a processor, a motherboard, and related components. The system 600 also includes a Basic Input/Output System (BIOS) 620 that facilitates start-up operations. The platform hardware 610 may exchange information with an ACPI driver 640 via an ACPI BIOS 630, ACPI registers 632, and/or ACPI tables 634 (and these may be part of the BIOS data and contained with the BIOS in a persistent memory element, such as flash memory). The ACPI driver 640 (e.g., an integral part of an operating system) may in turn communicate with an Operating System (OS) kernel 650 and one or more device drivers 642. The kernel 650 may exchange information with OS Power Management (OSPM) code 660 and one or more applications 670 that are executing in the system 600.

To save power, the ACPI system 600 may enter a number of different power states. The various power state may represent, for example, states in which the system 600 consumes an increasingly lower amount of power and application 670 instructions are not being executed by a processor in the platform hardware 610 (e.g., ACPI sleep states S1 or S2). In other power states, the system 600 may appear to be “turned off” to a user, such as when in ACPI sleep state S3, also referred to as “suspend to RAM” and ACPI sleep state S4, also referred to as “hibernate.”

According to some embodiments, a lower-power state is defined such that the system “suspends to flash” (or to another persistent memory device). Note one or more of the elements illustrated in FIG. 6 (or some other element) might act as a “power manager” to: (i) determine that the apparatus is to transition from the higher-power state to the lower-power state, (ii) copy the operating system image information from the volatile memory device to the persistent memory device, and (iii) arrange for the apparatus to transition from the higher-power state to the lower-power state. According to some embodiments, the power manager is associated with an Extensible Firmware Interface (EFI), such as an interface between the operating system and platform firmware.

Note that implementing such an approach in BIOS and/or EFI might allow for a modified S3 and/or S4 ACPI sleep state without significant changes to an existing operating system.

According to some embodiments, the following software algorithm may be used to provide power state transitions:

if (system is entering lower-power state)
{

operating system goes through pre-suspend process; // appli-
cations are
stopped, devices and buses are turned off
contents of system RAM are copied to persistent memory;

}
if (system is exiting lower-power state)
{

BIOS copies RAM image from persistent memory to system RAM;
BIOS hands control over to operating system; // as in typical
resume
operating system resumes from where it left off;

}

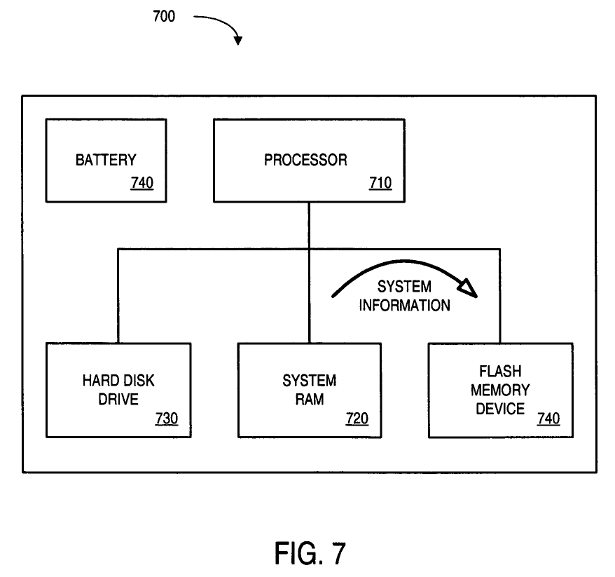

FIG. 7 illustrates a computer system 700 according to some embodiments. The computing system 700 may consume power from a battery 740 and operate in accordance with any of the embodiments described herein. For example, the computing system might include a processor 710, a system RAM 720, a hard disk drive 730, and a flash memory device 740. Moreover, system information may be copied from the system RAM 720 to the flash memory device 740 in connection with a transition from a first power state to a second power state. According to other embodiments a different type of low-latency, persistent memory may be used (e.g., a polymer-based memory).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although ACPI power states have been used herein as an example, embodiments of the present invention may be associated with any type of lower-power state. Moreover, although specific components have been described as performing specific functions, any of the functions described herein might be performed by a software application, a hardware device, an operating system, a driver, and/or a BIOS.

The several embodiments described herein are solely for the purpose of illustration. Persons skilled in the art will recognize from this description other embodiments may be practiced with modifications and alterations limited only by the claims.

What is claimed is:

1. A method, comprising:
determining that a processing system is to transition from a higher-power state to a lower-power state;
copying system information from a volatile memory device to a persistent memory device; and
arranging for the processing system to transition from the higher-power state to the lower-power state.

2. The method of claim 1, wherein the higher-power state is an advanced configuration and power interface specification power state.

3. The method of claim 2, wherein the higher-power state is associated with at least one of: (i) a global state, (ii) a device power state, (iii) a sleep state, (iv) a processor power state, or (v) a performance state.

4. The method of claim 1, wherein the persistent memory device comprises at least one of: (i) an electrically erasable programmable read-only memory device, (ii) a flash memory device, (iii) a polymer-based memory device, (iv) a magnetoresistive random access memory device, (v) an ovonic unified memory device, (vi) a ferroelectric random access memory device, (vii) a ferroelectric polymer random access memory device, or (viii) a resistance random access memory device.

5. The method of claim 1, wherein the volatile memory is a system random access memory device and the system information comprise an operating system image.

6. The method of claim 1, further comprising:
determining that a processing system is to transition back from the lower-power state to the higher-power state;
copying system information from the persistent memory device to the volatile memory device; and
arranging for the processing system to transition from the lower-power state to the higher-power state.

7. The method of claim 1, wherein the processing system comprises at least one of: (i) a desktop personal computer; (ii) a mobile computer, (iii) a workstation, (iv) a server, (v) a set-top box, (vi) a wireless telephone, (vii) a consumer electronic device, or (viii) a game system.

8. The method of claim 1, wherein said determining is performed by at least one of: (i) a software application, (ii) a hardware device, (iii) an operating system, (iv) a driver, or (v) a basic input/output system.

9. An apparatus, comprising:
a processor;
a volatile memory to store operating system image information when the apparatus is in a higher-power state; and
a persistent memory device to store the operating system image information when the apparatus is in a lower-power state.

10. The apparatus of claim 9, further comprising:
a power manager to: (i) determine that the apparatus is to transition from the higher-power state to the lower-power state, (ii) copy the operating system image information from the volatile memory device to the persistent memory device, and (iii) arrange for the apparatus to transition from the higher-power state to the lower-power state.

11. The apparatus of claim 10, wherein the power manager is further to: (i) determine that the apparatus is to transition back from the lower-power state to the higher-power state; copy the operating system image information from the persistent memory device to the volatile memory device, and (iii) arrange for the apparatus to transition from the lower-power state to the higher-power state.

12. The apparatus of claim 10, wherein the power manager is associated with at least one of: (i) a software application, (ii) a hardware device, (iii) an operating system, (iv) a driver, or (v) a basic input/output system.

13. The apparatus of claim 9, wherein the higher-power state is an advanced configuration and power interface specification power state.

14. The apparatus of claim 13, wherein the higher-power state is associated with at least one of: (i) a global state, (ii) a device power state, (iii) a sleep state, (iv) a processor power state, or (v) a performance state.

15. The apparatus of claim 9, wherein the persistent memory device comprises at least one of: (i) an electrically erasable programmable read-only memory device, (ii) a flash memory device, (iii) a polymer-based memory device, (iv) a magnetoresistive random access memory device, (v) an ovonic unified memory device, (vi) a ferroelectric random access memory device, (vii) a ferroelectric polymer random access memory device, or (viii) a resistance random access memory device.

16. The apparatus of claim 9, wherein the volatile memory is a system random access memory device.

17. The apparatus of claim 9, wherein the apparatus comprises at least one of: (i) a desktop personal computer; (ii) a mobile computer, (iii) a workstation, (iv) a server, (v) a set-top box, (vi) a wireless telephone, or (vii) a game system.

18. A computer system, comprising:
a processor;
a battery to supply power to the processor;
a volatile memory to store context information when the computer system is in a first power state; and
a persistent memory device to store the context information when the computer system is in a second power state.

19. The computer system of claim 18, further comprising:
a power manager to: (i) determine that the computer system is to transition from the first power state to the second power state, (ii) copy the context information from the volatile memory device to the persistent memory device, and (iii) arrange for the computer system to transition from the first power state to the second power state.

20. The computer system of claim 19, wherein the power manager is further to: (i) determine that the computer system is to transition back from the second power state to the first power state; copy the context information from the persistent memory device to the volatile memory device, and (iii) arrange for the computer system to transition from the second power state to the first power state.

21. The computer system of claim 19, wherein the power manager is associated with at least one of: (i) a software application, (ii) a hardware device, (iii) an operating system, (iv) a driver, or (v) a basic input/output system.

22. The computer system of claim 18, wherein the first power state is an advanced configuration and power interface specification power state.

23. The computer system of claim 22, wherein the first power state is associated with at least one of: (i) a global state, (ii) a device power state, (iii) a sleep state, (iv) a processor power state, or (v) a performance state.

24. The computer system of claim 18, wherein the persistent memory device comprises at least one of: (i) an electrically erasable programmable read-only memory device, (ii) a flash memory device, (iii) a polymer-based memory device, (iv) a magnetoresistive random access memory device, (v) an ovonic unified memory device, (vi) a ferroelectric random access memory device, (vii) a ferroelectric polymer random access memory device, or (viii) a resistance random access memory device.

25. An article, comprising:
a storage medium having stored thereon instructions that when executed by a machine result in the following:
determine that a processing system is to transition from a higher-power state to a lower-power state;
copy system information from a system random access memory to a flash memory; and
arrange for the processing system to transition from the higher-power state to the lower-power state.

26. The article of claim 25, wherein the higher-power state is an advanced configuration and power interface specification power state.

27. The article of claim 26, wherein the higher-power state is associated with at least one of: (i) a global state, (ii) a device power state, (iii) a sleep state, (iv) a processor power state, or (v) a performance state.
